(19) United States
(12) Patent Application Publication
(10) Pub. No.: US 2017/0106776 A1
(43) Pub. Date: Apr. 20, 2017

(54) INFANT CAR SEAT LINER SYSTEMS

(71) Applicant: Danielle Catherine Derby, Surrey (CA)

(72) Inventor: Danielle Catherine Derby, Surrey (CA)

(21) Appl. No.: 14/887,581

(22) Filed: Oct. 20, 2015

(51) Int. Cl. B60N 2/60; B60N 3/10; B60N 2/28

(52) U.S. Cl. CPC B60N 2/60; B60N 2/2845; B60N 3/103; B60N 2/6054; B60N 2/6018

(57) ABSTRACT

An infant car seat liner system for providing an effective means for protecting car seats and storing removable items (infant supplies and related articles) such that a parent may combine the function of a diaper bag and a car seat. The infant car seat liner system has a front surface, a back surface, and at least one pocket. The infant car seat liner is flexible and is structured and arranged such that an infant-user is able to be removed from a car seat without removing the infant car seat liner.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of covers for infant car seats and more specifically relates to an infant car seat liner system that may be used to store items for removable use and protect the host car seat from damage.

### 2. DESCRIPTION OF RELATED ART

For safety reasons, child car seats have become mandatory. They are constantly in use today. Infant car seats are required in many states and are used by many parents. These seats are designed to protect the infant by reducing the possibility of injury in the event of a motor vehicle accident. Infant car seats are provided with a structure which enables the infant seat to be affixed to the seat of a vehicle. Straps, which may be fastened around the child, are provided to retain the infant in the infant seat in the event of an accident or sudden stop.

A child may be confined for long periods of time in the car seat. Infant seats are subject to spills of food, beverages and to otherwise being soiled. Provisions must be made for food, drink, and entertainment for the child while confined in the car seat. Any of these comestibles can cause a messy situation with crumbs and spills. Other problems may arise, such as a leaking diaper or a child throwing up. When any of these events occur the car seat must be cleaned out before the child can be placed back in the car seat in a clean, comfortable environment. The infant seats can be difficult to clean and keep sanitary. All of these options can cause a considerable delay in plans. Another consideration is the effect of the spills and accidents on the vehicle upholstery. The seats are commonly manufactured of a cloth material or vinyl which is difficult to clean. A suitable solution is desired.

Several attempts have been made to solve the above-mentioned problems such as those found in U.S. and International Pat. and Pub. Nos. U.S. Pat. Nos. 7,284,790; 9,079,521; 6,786,546; CA 2,212,497; U.S. Pat. Nos. 5,988,742; 6,481,791; 6,428,098; 5,005,901; 2,397,441; 7,195,314; 5,243,724; 6,561,588; 2013/0057032; 2015/0028639; 2,416,498; 2013/0292973; 2010/0038939. This art is representative of infant car seat liners. However, none of the above inventions and patents, taken either singly or in combination, is seen to describe the invention as claimed.

Preferably, an infant car seat liner system should provide protection for car seats and storage for various child-related items and, yet would operate reliably and be manufactured at a modest expense. Thus, a need exists for a reliable infant car seat liner system to avoid the above-mentioned problems.

### BRIEF SUMMARY OF THE INVENTION

In view of the foregoing disadvantages inherent in the known infant car seat art, the present invention provides a novel infant car seat liner system. The general purpose of the present invention, which will be described subsequently in greater detail is to provide an effective means for protecting car seats and storing removable items (infant supplies and related articles) such that a parent may combine the function of a diaper bag and a car seat.

An infant car seat liner system as disclosed herein, in a preferred embodiment, comprising an infant car seat liner assembly. Infant car seat liner assembly comprises an infant car seat liner having a front surface, a back surface, and at least one pocket; wherein the infant car seat liner system comprises the infant car seat liner assembly. The infant car seat liner assembly comprises the infant car seat liner. The infant car seat liner is flexible and is structured and arranged such that an infant-user is able to be removed from a car seat without removing the infant car seat liner. The infant car seat liner is defined by the front surface and the back surface such that it is able to maintain a coupled and conformed relationship with the car seat (bottom seat portion) when used.

The infant car seat liner assembly is designed (and structured and arranged) to be affixed to the car seat and not readily removed when the infant-user is removed from the car seat. The infant car seat liner, in preferred embodiments, occupies a position during an in-use condition under the buttocks of the infant-user; the infant car seat liner not covering a back of the infant-user in the in-use condition. The back surface is adjacent to the car seat during use; the front surface contacting the infant-user during use. The infant car seat liner occupies a position, during the in-use condition, under the forearms and elbows of the infant-user. The infant car seat liner does not cover under the hands of the infant-user in the in-use condition.

The infant car seat liner is shaped to fit around and conform to arms of the car seat via a first-aperture and a second-aperture. The first-aperture and the second-aperture are located at respective front-ends of the arms of the car seat and the frontends protrude through the apertures. The infant car seat liner comprises a first-flap and a second-flap; the first-flap and the second-flap drape over respective arms of the car seat. The flap has at least one pocket that is able to store items for removable use. At least one pocket is structured and arranged to vertically contain the items. The pocket(s) lie vertically adjacent to the arms of the car seat (hang down from). Certain embodiments may comprise a small pocket for a soother that sits beside the infant.

Preferred embodiments have the at least one pocket comprising thermal-lining. The thermal-lining resists thermal change from occurring within and from the at least one pocket. The thermal resistance restricts heat and cold (lack of heat) from passing inwardly and outwardly via insulative means. The at least one pocket preferably comprises a right-pocket and a left-pocket. The infant car seat liner comprises seat-belt access openings such that it doesn't impair the normal safety features of the car seat. The right-pocket and the left-pocket each respectively preferably comprise cover-flaps. The infant car seat liner is secured in to place via fasteners to a lower portion of the car seat. An elastic that wraps around the handle base of the car seat and attaches to a clip on the car seat liner may be used. The infant car seat liner is useful for protecting the car seat from damage and for storing at least one item for convenience in the removable use of the items.

A method of using an infant car seat liner system is also disclosed herein comprising the steps of: installing an infant car seat liner assembly on to a lower portion of a car seat, and securing the infant car seat liner assembly to the car seat via fasteners. The method may further comprise the steps of opening cover-flaps such that at least one item is able to be stored vertically within the at least one pocket and closing the cover-flaps such that the at least one item is thermally storable. The items may be repeatedly removed for use and storage as necessary.

The present invention holds significant improvements and serves as an infant car seat liner system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, infant car seat liner system, constructed and operative according to the teachings of the present invention.

FIG. 1 shows a perspective view illustrating an infant car seat liner system during an ‘in-use’ condition according to an embodiment of the present invention.

FIG. 2 is a perspective view illustrating the infant car seat liner assembly of the car seat system with an infant-user sitting therein according to an embodiment of the present invention of FIG. 1.

FIG. 3 is a perspective view illustrating the infant car seat liner system assembly of the car seat system without the infant-user sitting therein according to an embodiment of the present invention of FIGS. 1-2.

FIG. 4 is a perspective view illustrating the infant car seat liner system assembly of the car seat system with items stored in the at least one pocket according to an embodiment of the present invention of FIGS. 1-3.

FIG. 5 is a method of use for the infant car seat liner system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to an infant car seat liner system and more particularly to an infant car seat liner that may be left in the car seat after removing a child used to improve the accessibility of items while caring for an infant and simultaneously providing protection for the car seat from wear and staining.

Generally speaking, the invention comprises an infant car seat liner that provides multiple pockets for storage for the usual supplies you would find in a diaper bag (eg: diaper, wipes, bottle, soother, parents keys, cards, money etc.) The invention fits onto the front and inside of an infant car seat and functions as a diaper bag as well as a liner for the car seat. It has multiple pockets including thermal lined pocket(s) to keep baby bottles/food warm or cool, a small pocket that sits beside the baby and holds a soother, a front pocket that can fit money/cards and another two large side pockets. The liner is secured in place using durable elastic and has three looped ribbons for the baby to play with. Upon reading this specification, it should be appreciated that, under appropriate circumstances, considering such issues as user preferences, design preference, structural requirements, marketing preferences, cost, available materials, technological advances, etc., other fastening means and arrangements such as, for example, elastic and non-elastic ties, clips, fasteners, ties, etc., may be sufficient.

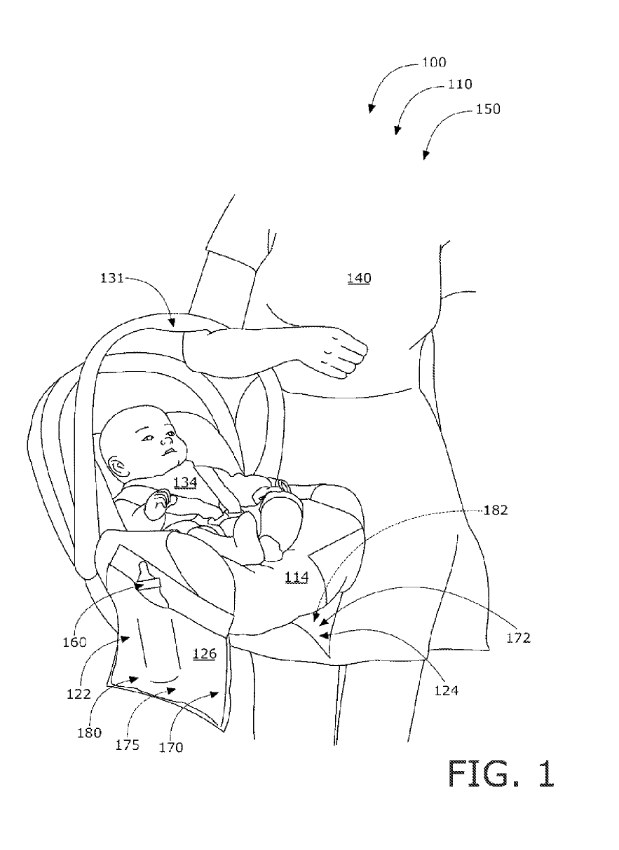

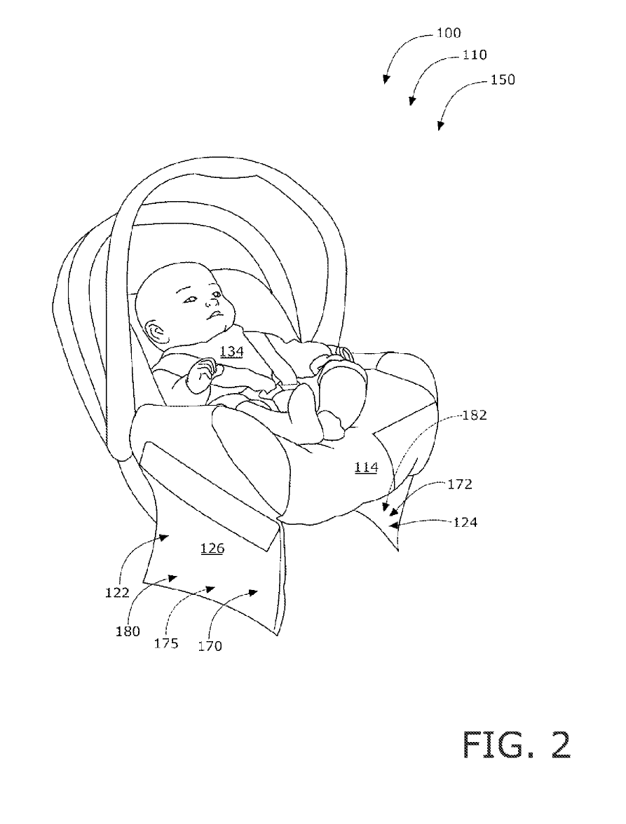

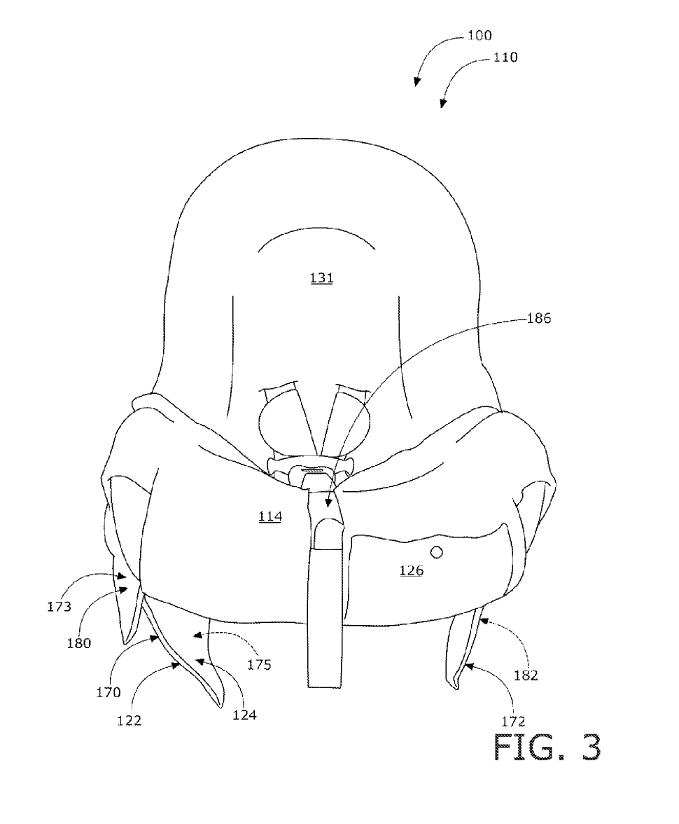

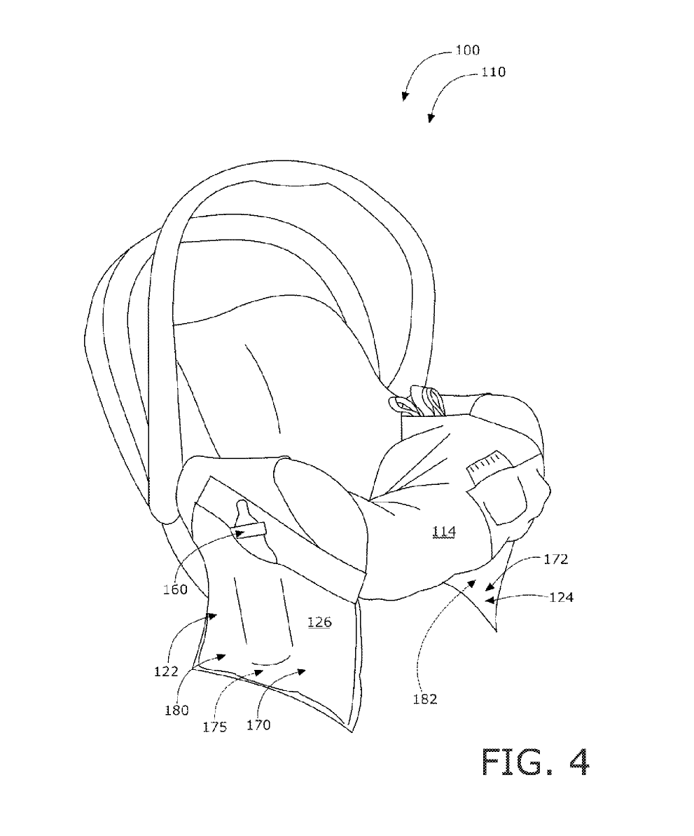

Referring now to the drawings by numerals of reference there is shown in FIGS. 1-4, various views of infant car seat liner system 100 comprising infant car seat liner assembly 110. Infant car seat liner assembly 110 comprises an infant car seat liner 120 having front surface 122, back surface 124, and at least one pocket 126. Infant car seat liner system 100 comprises infant car seat liner assembly 110.

Infant car seat liner assembly 110 comprises infant car seat liner 100 which is flexible and is structured and arranged such that an infant-user 134 is able to be removed from car seat 131 without removing infant car seat liner 114. Infant car seat liner 114 is defined by front surface 122 and back surface such that it is able to maintain a coupled and conformed relationship with car seat 131 when used.

Back surface 124 is adjacent to car seat 131 during use and front surface 122 contacts infant-user 134 during use. At least one pocket 126 is able to store at least one item 160 for removable use; wherein infant car seat liner 120 is useful for protecting car seat 131 from damage and for storing the at least one item 160 for convenience in the removable use of at least one item 160. Infant car seat liner assembly 110 is designed and structured and arranged to be affixed to car seat 131 and not readily removed when infant-user 134 is removed from car seat 131. Infant car seat liner 120 occupies a position during an in-use condition under the buttocks of infant-user 134, as shown in FIG. 1. Infant car seat liner 120 does not cover the back of infant-user 134 in the in-use condition. Infant car seat liner 134 occupies a position during an in-use condition under the forearms and elbows of infant-user 134, infant car seat liner 120 does not cover under the hands of the infant-user 134 in the in-use condition, as shown.

Infant car seat liner 120 is shaped to fit around and conform to the arms of car seat 131 via first-aperture 165 and second-aperture 168; first-aperture 165 and second-aperture 168 are located at respective front-ends of the arms of car seat 131. Infant car seat liner 120 comprises first-flap 170 and second-flap 172. Infant car seat liner system 100 comprises first-flap 170 and second-flap 172 which drape over respective the arms of car seat 131.

At least one pocket 126 is structured and arranged to vertically (removably) contain at least one item 160. Infant car seat liner system 100 has at least one pocket 126 which lies vertically adjacent to the arms of car seat 131 during use. At least one pocket 126 comprises thermal-lining 175; thermal-lining 175 resists thermal change from occurring within at least one pocket 126. At least one pocket 126 comprises right-pocket 180 and left-pocket 182. Infant car seat liner 120 comprises seat-belt access openings 186. Right-pocket 180 and left-pocket 182 each respectively comprise cover-flaps 173. Infant car seat liner 120 is secured in place via durable elastic. Infant car seat liner assembly 110 may comprise any suitable fabric or the like.

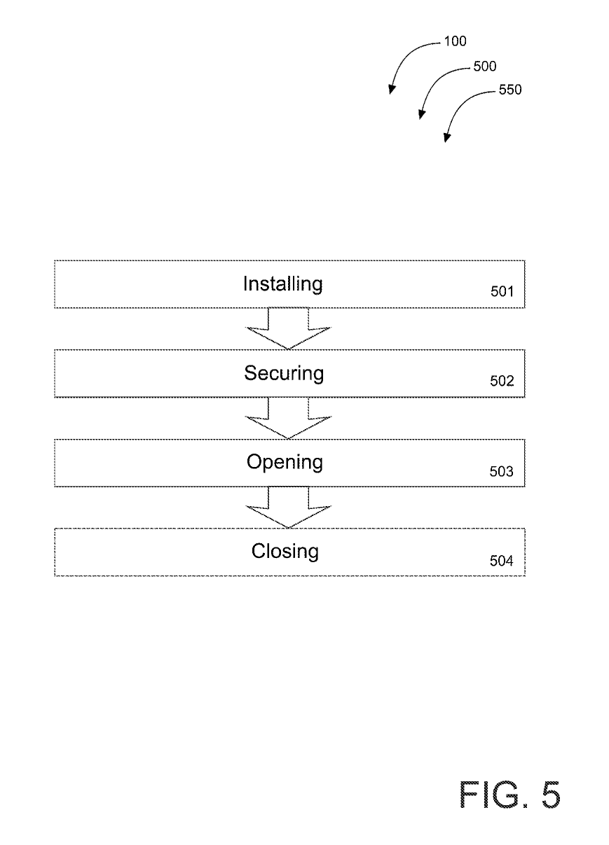

Referring now to FIG. 5 showing flowchart 550 illustrating method of use 500 for infant car seat liner system 100 according to an embodiment of the present invention of FIGS. 1-4.

As shown, method of use 500 may comprise the steps of: step one 501, installing infant car seat liner assembly 110 on to a lower portion of a car seat 131, and step two 502 securing infant car seat liner assembly 110 to car seat 131 via fastening means. The method 500 further comprises the step three 503 of opening cover-flaps 173 such that at least one item 160 is able to be stored vertically within at least one pocket 126. Step four 504 may comprise closing cover-flaps 173 such that the at least one item 160 is thermally storable.

It should be noted that step 504 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An infant car seat liner system comprising:
an infant car seat liner assembly comprising;
an infant car seat liner having;
a front surface;
a back surface; and
at least one pocket;
wherein said infant car seat liner system comprises said infant car seat liner assembly;
wherein said infant car seat liner assembly comprises said infant car seat liner;
wherein said infant car seat liner is flexible and is structured and arranged such that an infant-user is able to be removed from a car seat without removing said infant car seat liner, said infant car seat liner defined by said front surface and said back surface such that it is able to maintain a coupled and conformed relationship with said car seat when used;
wherein said back surface is adjacent to said car seat during use, said front surface contacting said infant-user during use;
wherein said at least one pocket is able to store at least one item for removable use; and
wherein said infant car seat liner is useful for protecting said car seat from damage and for storing said at least one item for convenience in said removable use of said at least one item.

2. The infant car seat liner system of claim 1 wherein said infant car seat liner assembly is designed and structured and arranged to be affixed to said car seat and not readily removed when said infant-user is removed from said car seat.

3. The infant car seat liner system of claim 2 wherein said infant car seat liner occupies a position during an in-use condition under buttocks of said infant-user, said infant car seat liner not contacting a back of said infant-user in said in-use condition.

4. The infant car seat liner system of claim 3 wherein said infant car seat liner occupies a position during said in-use condition under forearms and elbows of said infant-user, said infant car seat liner not covering under hands of said infant-user in said in-use condition.

5. The infant car seat liner system of claim 3 wherein said infant car seat liner is shaped to fit around and conform to arms of said car seat via a first-aperture and a second-aperture.

6. The infant car seat liner system of claim 5 wherein said first-aperture and said second-aperture are located at respective front-ends of said arms of said car seat.

7. The infant car seat liner system of claim 6 wherein said infant car seat liner comprise a first-flap and a second-flap.

8. The infant car seat liner system of claim 7 wherein said first-flap and said second-flap drape over respective said arms of said car seat.

9. The infant car seat liner system of claim 8 wherein said at least one pocket is structured and arranged to vertically contain said at least one item.

10. The infant car seat liner system of claim 9 wherein said at least one pocket lies vertically adjacent to said arms of said car seat.

11. The infant car seat liner system of claim 1 wherein said at least one pocket comprises thermal-lining.

12. The infant car seat liner system of claim 11 wherein said thermal-lining resists thermal change from occurring within said at least one pocket.

13. The infant car seat liner system of claim 12 wherein said at least one pocket comprises a right-pocket and a left-pocket.

14. The infant car seat liner system of claim 13 wherein said infant car seat liner comprises seat-belt access openings.

15. The infant car seat liner system of claim 14 wherein said right-pocket and said left-pocket each respectively comprise cover-flaps.

16. The infant car seat liner system of claim 1 wherein said infant car seat liner is secured in place via fasteners to a lower portion of said car seat.

17. An infant car seat liner system comprising:
an infant car seat liner assembly comprising;
an infant car seat liner having;
a front surface;
a back surface; and
at least one pocket;
wherein said infant car seat liner system comprises said infant car seat liner assembly;
wherein said infant car seat liner assembly comprises said infant car seat liner;
wherein said infant car seat liner is flexible and is structured and arranged such that an infant-user is able to be removed from a car seat without removing said infant car seat liner, said infant car seat liner defined by said front surface and said back surface such that it is able to maintain a coupled and conformed relationship with said car seat when used;
wherein said infant car seat liner assembly is designed and structured and arranged to be affixed to said car seat and not readily removed when said infant-user is removed from said car seat;
wherein said infant car seat liner occupies a position during an in-use condition under buttocks of said infant-user, said infant car seat liner not covering a back of said infant-user in said in-use condition;
wherein said back surface is adjacent to said car seat during use, said front surface contacting said infant-user during use;
wherein said infant car seat liner occupies a position during said in-use condition under forearms and elbows of said infant-user, said infant car seat liner not covering under hands of said infant-user in said in-use condition;
wherein said infant car seat liner is shaped to fit around and conform to arms of said car seat via a first-aperture and a second-aperture;
wherein said first-aperture and said second-aperture are located at respective front-ends of said arms of said car seat;
wherein said infant car seat liner comprise a first-flap and a second-flap;
wherein said first-flap and said second-flap drape over respective said arms of said car seat;
wherein said at least one pocket is able to store at least one item for removable use;
wherein said at least one pocket is structured and arranged to vertically contain said at least one item;
wherein said at least one pocket lies vertically adjacent to said arms of said car seat;
wherein said at least one pocket comprises thermal-lining;
wherein said thermal-lining resists thermal change from occurring within and from said at least one pocket;
wherein said at least one pocket comprises a right-pocket and a left-pocket;
wherein said infant car seat liner comprises seat-belt access openings;
wherein said right-pocket and said left-pocket each respectively comprise cover-flaps;
wherein said infant car seat liner is secured in place via fasteners to a lower portion of said car seat; and
wherein said infant car seat liner is useful for protecting said car seat from damage and for storing said at least one item for convenience in said removable use of said at least one item.

18. A method of using an infant car seat liner system comprising the steps of:
installing an infant car seat liner assembly on to a lower portion of a car seat; and
securing said infant car seat liner assembly to said car seat via fasteners.

19. The method of claim 18 further comprising the step of:
opening cover-flaps such that at least one item is able to be stored vertically within said at least one pocket.

20. The method of claim 19 further comprising the step of:
closing said cover-flaps such that said at least one item is thermally storable.
